(19) United States
(12) Patent Application Publication
(10) Pub. No.: US 2014/0242818 A1
(43) Pub. Date: Aug. 28, 2014

(54) CONNECTOR FITTING STRUCTURE

(71) Applicant: Yazaki Corporation, Tokyo (JP)

(72) Inventor: Takenori Ohmura, Kakegawa-shi (JP)

(73) Assignee: YAZAKI CORPORATION, Tokyo (JP)

(21) Appl. No.: 14/355,305

(22) PCT Filed: Oct. 29, 2012
(86) PCT No.: PCT/JP2012/006923

§ 371 Date: Apr. 30, 2014

(30) Foreign Application Priority Data
Oct. 31, 2011 (JP) 2011-238939

(51) Int. Cl. H01R 13/629

(52) U.S. Cl. CPC H01R 13/629
USPC 439/155

(57) ABSTRACT

A connector fitting structure is composed of a power-feed connector and a power-receiving connector. The power-feed connector includes: a case; a connector main body having a power-line terminal; a lever for moving the connector main body forward and backward; and a lock arm for locking both cases with each other by engaging with a case of the power-receiving connector. In the connector fitting structure, while both cases are locked with each other and the connector main body is positioned in a front position, the connector main body is fitted with a connector main body of the power-receiving connector. Further, while both cases are locked with each other and the connector main body is positioned in a rear position, the power-line terminal is in contact with a power-line terminal of the power-receiving connector.

### TECHNICAL FIELD

This invention relates to a connector fitting structure between a power-feed connector provided on a power-feed device for charging a battery of such as an electric vehicle and a power-receiving connector provided on the electric vehicle, and relates to the power-feed connector used in the connector fitting structure.

[Back Ground Art]

FIG. 4 is a partially sectional view showing a conventional connector fitting structure between a power-feed connector and a power-receiving connector. FIG. 5 is an enlarged view enlarging an R portion of FIG. 4 (see PTL1).

As shown in FIG. 4, the above connector fitting structure 310 is composed of the power-feed connector 301 and the power-receiving connector 101 fitted to each other. This power-feed connector 301 is provided on a power-feed device for charging a battery of an electric vehicle, and the power-receiving connector 101 is provided on the electric vehicle.

The power-feed connector 301 includes: a case 302 provided at a tip of a cable of the power-feed device; a connector main body mounted movably in the case 302 and having a power-line terminal 304a connected to a power line 303a and a signal-line terminal 304b connected to a signal line 303b; a lever 306 for moving the connector main body 305 forward and backward relative to the case 302; a lock arm 307 for locking both cases 302, 102 of both connectors 301, 101 with each other by engaging with the case 102 of the power-receiving connector 101; a lock-arm-release member (not shown) for releasing an engagement between the case 102 and the lock arm 307; and a lever-fixing member (not shown) for fixing the lever 306 at a position denoted by a two-dot chain line.

The power-receiving connector 101 includes: a case 102 fixed to a vehicle body; and a connector main body 105 mounted in the case 102 and having a power-line terminal 104a connected to a power line 103a and a signal-line terminal 104b connected to a signal line 103b.

In such a connector fitting structure 310, when the power-feed connector 301 is moved close to the power-receiving connector 101, the lock arm 307 is engaged with the case 102 of the power-receiving connector 101, and both cases 302, 102 of both connectors 301, 101 are locked with each other. Then, in this condition, when the lever 306 is moved along an arrow A in FIG. 4, the connector main body 305 of the power-feed connector 301 is moved forward along an arrow B in FIG. 4 from a rear position to a front position, and fitted with the connector main body 105 of the power-receiving connector 101. Further, after the 306 is fixed to the position denoted by the two-dot chain line with the lever-fixing member, a charge from the power-feed device to the battery is started.

Further, when the power-feed connector 301 is disengaged from the power-receiving connector 101 after the charge is finished and the power feed to the power line is stopped, firstly, the lever 306 is returned from the position denoted by the two-dot chain line to a position denoted by a solid line with the lever-fixing member, and the connector main body 305 is released from the connector main body 105. Then, the engagement between the case 102 and the lock arm 307 is released with the lock-arm-release member, and thereby the lock between both cases 302, 102 is released. In this condition, when the power-feed connector 301 is pulled off from the power-receiving connector 101, the power-feed connector 301 is separated from the power-receiving connector 101.

### CITATION LIST

### Patent Literature

[PTL 1]
JP, A, H10-275653

### SUMMARY OF INVENTION

### Technical Problem

However, in the conventional connector fitting structure 310 and the conventional power-feed connector 301, there is a problem described below. Namely, while the battery is charged from the feeding device after the power-feed connector 301 and the power-receiving connector 101 are fitted with each other, when the lever 306 is moved due to an operation error and the connector main body 305 is separated from the connector main body 105, as shown in FIG. 5, the power-line terminals 304a, 104a come into non-contact with each other, and an arc discharge is generated between the power-line terminals 304a and 104a, thereby there is a problem that the connectors 301, 101 are damaged.

Accordingly, an object of the present invention is to provide a connector fitting structure able to prevent an arc discharge from being generated.

### Solution to Problem

For attaining the object, according to a first aspect of the present invention, there is provided a connector fitting structure including:

a power-feed connector; and
a power-receiving connector configured to be fitted with the power-feed connector,
said power-feed connector including;
a case;
a connector main body mounted movably forward and backward in the case and having a power-line terminal connected to a power line;
a lever for moving the connector main body forward and backward relative to the case; and
a lock member for locking both cases of both connectors with each other by engaging with a case of the power-receiving connector,
wherein when the power-feed connector and the power-receiving connector are moved close to each other, the lock member locks both cases of both connectors with each other,
wherein while both cases of both connectors are locked with each other and the connector main body of the power-feed connector is positioned in a front position, the connector main body of the power-feed connector is fitted with a connector main body of the power-receiving connector, and
wherein while both cases of both connectors are locked with each other and the connector main body of the power-feed connector is positioned in a rear position, the power-line terminal of the power-feed connector is in contact with a power-line terminal of the power-receiving connector.

According to a second aspect of the present invention, there is provided the connector fitting structure as described in the first aspect,

wherein both main bodies of both connectors include the power-line terminals connected to the power line and signal-line terminals connected to a signal line,
wherein while both cases of both connectors are locked, with each other and the connector main body of the power-feed connector is positioned in the front position, the signal-line terminal of the power-feed connector is in contact with the signal-line terminal of the power-receiving connector, and
wherein while both cases of both connectors are locked with each other and the connector main body of the power-feed connector is positioned in the rear position, the signal-line terminal of the power-feed connector is in non-contact with the signal-line terminal, of the power-receiving connector.

### Advantageous Effects of Invention

According to the invention as described in the first aspect, while both cases of both connectors are locked with each other and the connector main body of the power-feed connector is positioned in a rear position, the power-line terminal of the power-feed connector is in contact with a power-line terminal of the power-receiving connector. Therefore, while the electric power is supplied from a power-feed connector side to a power-receiving connector side, when the lever is moved due to an operation error and the connector main body of the power-feed connector is positioned in the rear position, the arc discharge is prevented from being generated between the power-line terminals of the power-feed connector and the power-receiving connector. Therefore, the power-feed connector and the power-receiving connector are prevented from being damaged.

According to the invention as described in the second aspect, while both cases of both connectors are locked with each other and the connector main body of the power-feed connector is positioned in the rear position, the signal-line terminal of the power-feed connector is in non-contact with the signal-line terminal of the power-receiving, connector. Therefore, while the electric power is supplied from a power-feed connector side to a power-receiving connector side, when the lever is moved due to an operation error and the connector main body of the power-feed connector is positioned in the rear position, the power distribution between the power-line terminals can be stopped. Further, when the power-line terminals are separated from each other after the power distribution between the power-line terminals is stopped, the arc discharge is surely prevented from being generated.

### BRIEF DESCRIPTION OF DRAWINGS

FIG. 1 is a partially sectional view showing a connector fitting structure according to an embodiment of the present invention, and showing a condition that both cases of both connectors are locked with each other, and a connector main body of a power-feed connector is positioned in a rear position.

FIG. 2 is an enlarged view enlarging a main part of the connector fitting structure shown in FIG. 1.

FIG. 3 is a partially sectional view showing a condition that the connector main body of the power-feed connector is positioned in a front position, and fitted with a connector main body of a power-receiving connector.

FIG. 4 is a partially sectional view showing a conventional connector fitting structure between a power-feed connector and a power-receiving connector.

FIG. 5 is an enlarged view enlarging an R portion of FIG. 4.

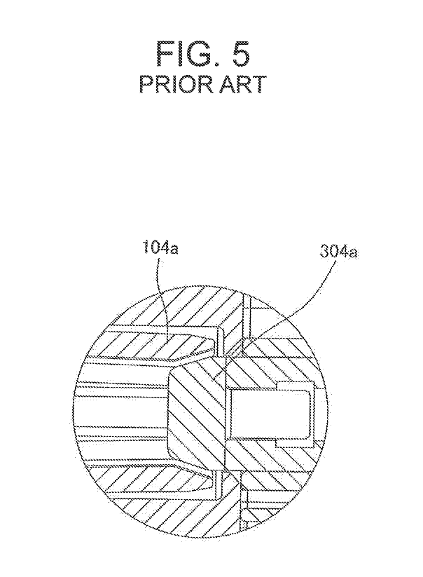

### DESCRIPTION OF EMBODIMENTS

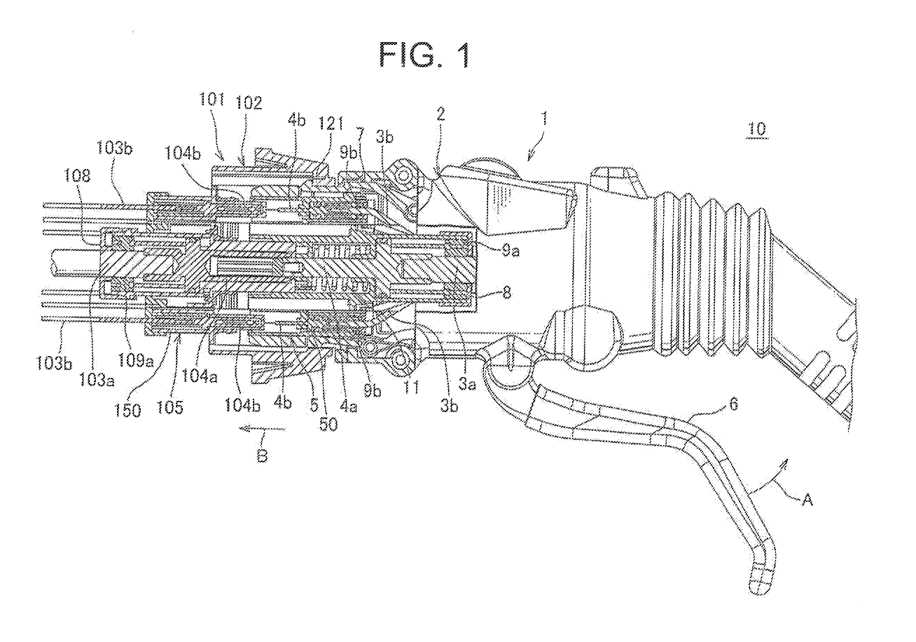

A connector fitting structure and a power-feed connector according to an embodiment of the present invention will be explained with reference to FIGS. 1 to 3.

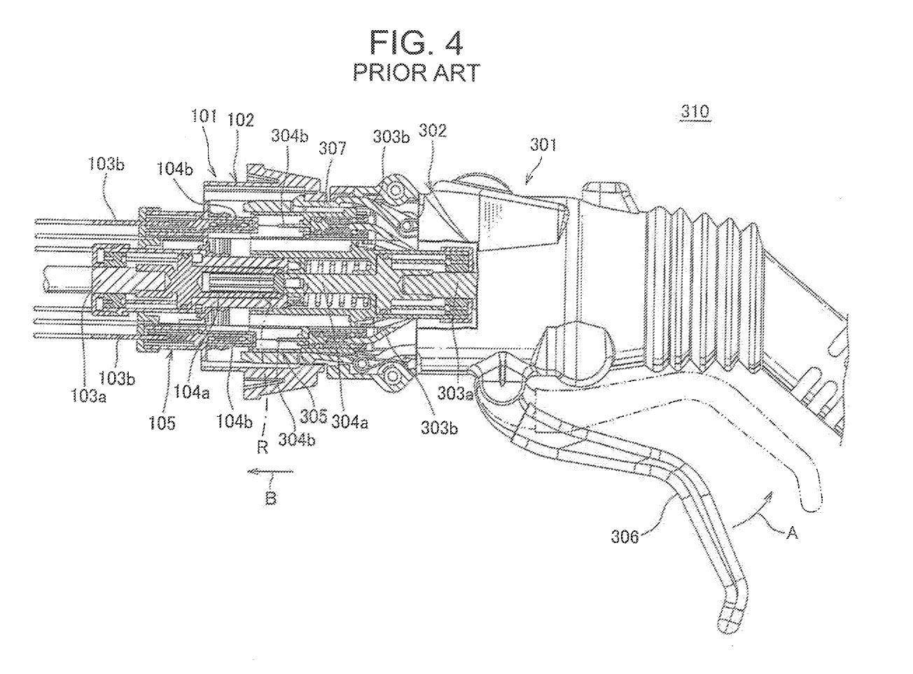

As shown in FIGS. 1 to 3, a connector fitting structure 10 of the present invention is composed of a power-feed connector 1 and a power-receiving connector 101 fitted with each other. This power-feed connector 1 is mounted on a power-feed device for charging a battery in an electric vehicle, and the power-receiving connector 101 is mounted on the electric vehicle. Further, the power-receiving connector 10l is the same as the power-receiving connector 101 explained as the conventional art. The power-feed connector 1 is a connector modifying the power-feed connector 301 in FIG. 4 explained as the conventional art.

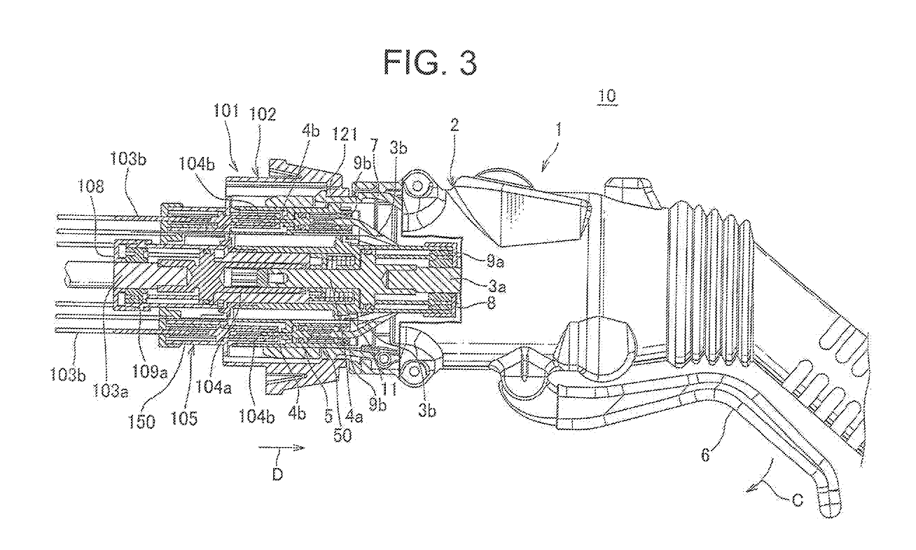

The power-feed connector 1 includes: a case 2 provided on a tip of a cable of the power-feed device; a connector main body 5 mounted movably forward and backward in the case 2 and having a power-line terminal 4a connected to a power line 3a and a signal-line terminal 4b connected to a signal line 3b; a lever 6 for moving the connector main body 5 forward and backward relative to the case 2; a lock arm 7 (lock member in claims) for locking both cases 2, 102 of both connectors 1, 101 with each other by engaging with the case 102 of the power-receiving connector 101; a lock-arm-release member (not shown) for releasing an engagement between the case 102 and the lock arm 7; a lever-fixing member (not shown) for fixing the lever 6 at a position shown in FIG. 3; and a coil spring 11 for pushing the connector main body 5 toward an opposite side of the power-receiving connector 101.

The connector main body 5 includes: the power-line terminal 4a and the signal-line terminal 4b as above described; a housing 50 provided with terminal-receiving chambers 51, 52 for receiving these terminals 4a, 4b; waterproof plugs 9a, 9b for waterproofing the terminal-receiving chambers 51, 52; and a rear holder 8 for preventing the terminals 4a, 4b from falling out of the terminal-receiving chambers 51, 52.

The power-line terminal 4a is made of conductive material and provided with an electric-wire-connecting portion 40 to be electrically connected to the power line 3a and a bar-shaped connecting portion 41 to be electrically connected to a power-line terminal 104a of the power-receiving connector 101. The signal-line terminal 4b is made of conductive material and provided with an electric-wire-connecting portion 43 to be electrically connected to the signal line 3b and a bar-shaped connecting portion 44 to be electrically connected to a signal-line terminal 104b of the power-receiving connector 101. Further, the power line 3a is an electric wire through which electric current for charging the battery of the electric vehicle flows, and the signal line 3b is an electric wire through which a signal for controlling on/off of the power distribution to the power line 3a is transmitted.

A center portion of the lever 6 is rotatably supported by the case 2, one and portion of the lever 6 is disposed outside of the case 2, and the other end portion of the lever 6 is disposed inside of the case 2 and connected to the connector main body 5. Further, the lever 6 is pushed to be positioned in a position shown in FIG. 1 by a not-shown spring. Further, by moving the lever 8 along an arrow A in FIG. 1, the connector main body 5 is moved forward from a rear position shown in FIG. 1, and positioned in a front position shown in FIG. 3. Further, the lever 6 positioned in a position shown in FIG. 3 is unrotatably fixed by the lever-fixing member. Further, by releasing the lever-fixing member from the lever 6, the lever 6 is moved along an arrow C in FIG. 3, and returned to the position shown in FIG. 1. Further, when the lever 6 is returned to the position shown in FIG. 1 from the position shown in FIG. 3, the connector main body 5 is moved backward from the front position shown in FIG. 3 along an arrow D and positioned in the rear position shown in FIG. 1.

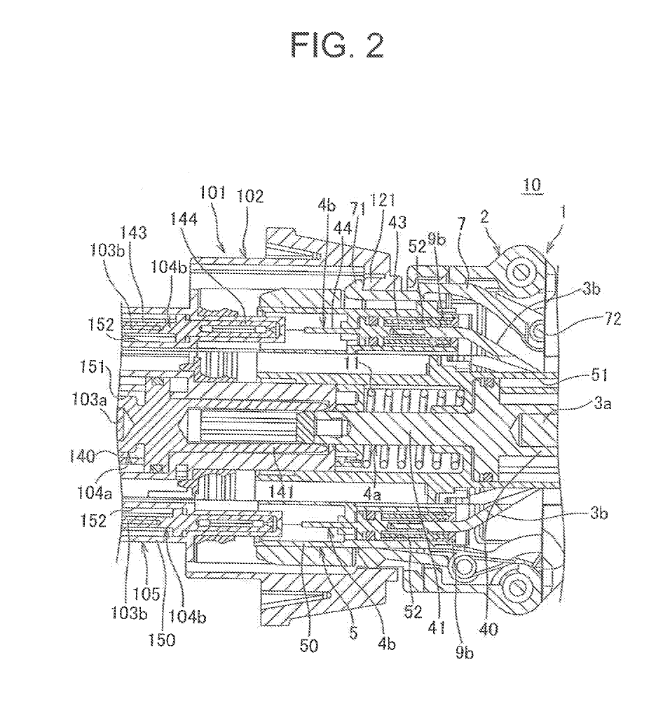

As shown in FIG. 2, a center portion of the lock arm 7 is rotatably supported by the case 2, one end portion of the lock arm 7 is disposed outside of the case 2, and the other end portion of the lock arm 7 is disposed inside of the case 2. Further, the lock arm 7 is pushed to be positioned in a position shown in FIGS. 1 and 2 by a not-shown spring. When the power-feed connector 1 and the power-receiving connector 101 are moved close to each other, one end 71 of the lock arm 7 is engaged with a front end 121 of the case 102 of the power-receiving connector 101 to lock the cases 2, 102 of the connectors 1, 101 with each other. Further, while the one end 71 of the lock arm 7 is engaged with the front end 121 of the case 102, when the other end of the lock arm 7 is pushed by the lock-arm-release member, the one end 71 is separated from the front end 121, and the engagement with the front: end 121 is released.

The power-receiving connector 101 includes: the case 102 fixed to a vehicle body; and a connector main body 105 mounted on an inside of the case 102 and having the power-line terminal 104a connected to the power line 103a and the signal-line terminal 104b connected to the signal line 103b.

The connector main body 105 includes: the power-line terminal 104a and the signal-line terminal 104b as above described: a housing 150 provided with terminal-receiving chambers 151, 152 for receiving these terminals 104a, 104b; a waterproof plug 109a for waterproofing the terminal-receiving chamber 151; and a rear holder 108 for preventing the terminals 104a, 104b from failing out of the terminal-receiving chambers 151, 152.

The power-line terminal 104a is made of conductive material and provided with an electric-wire-connecting portion 140 to be electrically connected to the power line 103a and a tubular-shaped connecting portion 141 to be electrically connected to the power-line terminal 4a of the power-feed connector 1. The signal-line terminal 104b is made of conductive material and provided with an electric-wire-connecting portion 143 to be electrically connected to the signal line 103b and a tubular-shaped connecting portion 144 to be electrically connected to the signal-line terminal 4b of the power-feed connector 1. Further, the power line 103a is an electric wire through which electric current for charging the battery of the electric vehicle flows, and the signal line 103b is an electric wire through which a signal for controlling on/off of the power distribution to the power line 103a is transmitted.

In such a connector fitting structure 10, when the power-feed connector 1 is moved close to the power-receiving connector 101, as shown in FIG. 1, the lock arm 7 is engaged with the case 102 of the power-receiving connector 101, and both cases 2, 102 of both connectors 1, 101 are locked with each other. Then, in this condition, when the lever 6 is moved along the arrow A of FIG. 1, the connector main body 5 of the power-feed connector 1 is moved forward along the arrow B from the rear position shown in FIG. 1 positioned in the front position shown in FIG. 3, and fitted with the connector main body 105 of the power-receiving connector 101. Further, when the connector main body 5 is fitted with the connector main body 105, the bar-shaped connecting portion 41 of the power-line terminal 4a is positioned at a rear side from a front side in the tubular-shaped connecting portion 141 of the power-line terminal 104a, and the bar-shaped connecting portion 44 of the signal-line terminal 4b is inserted into the tubular-shaped connecting portion 144 of the signal-line terminal 104b, thereby the signal-line terminal 4b and the signal-line terminal 104b are electrically connected to each other. Further, after the lever 6 is fixed to the position shown in FIG. 3 by the lever-fixing member, when a switch of the power-feed device is operated or the like, the charge from the power-feed device to the battery is started.

Further, after the charge is finished and the power distribution to the power line is shut off, when the power-feed connector 1 is released from the power-receiving connector 101, firstly, the lever 6 is returned to the position shown in FIG. 1 from the position shown in FIG. 3 by the lever-fixing member, thereby the connector main body 5 is moved backward from the front position shown in FIG. 3 to the rear position shown in FIG. 1 to separate the connector main body 5 from the connector main body 105. Further, when the connector main body 5 is separated from the connector main body 105, the bar-shaped connecting portion 41 of the power-line terminal 4a is positioned at the front side from the rear side in the tubular-shaped connecting portion 141 of the power-line terminal 104a, and the bar-shaped connecting portion 44 of the signal-line terminal 4b is positioned outside of the tubular-shaped connecting portion 144 of the signal-line terminal 104b, thereby the signal-line terminal 4b and the signal-line terminal 104b come into non-contact with each other. Then, the engagement between the case 102 and the lock arm 7 is released by the lock-arm-release member, thereby the lock between both cases 2, 102 is released. In this condition, by pulling out the power-feed connector 1 from the power-receiving connector 101, the power-feed connector 1 is separated from the power-receiving connector 101.

Next, a main improvement point of the power-feed connector 1 according to the present invention will be explained. In the power-feed connector 301 shown in FIG. 4 explained as the conventional art, while both cases 302, 102 of both connectors 301, 101 are locked with each other, and the connector main body 305 of the power-feed connector 301 is positioned in the rear position, the power-line terminal 304a of the power-feed connector 301 is in non-contact with the power-line terminal 104a of the power-receiving connector 101.

In contrast, in the power-feed connector 1 of the present invention, while both cases 2, 102 of both connectors 1, 101 are locked with each other and the connector main body 5 of the power-feed connector 1 is positioned in the rear position, the power-line terminal 4a of the power-feed connector 1 is in contact with and electrically connected to the power-line terminal 104a of the power-receiving connector 101. Concretely, a position of the connector main body 5 relative to the maneuvering gear 2 is closer to the power-receiving connector 101 than the connector main body 305 of the conventional power-feed connector 301.

According to the above improvement, the connector fitting structure 10 of the present invention produces an effect described below. Namely, while the electric power is supplied from the power-feed connector 1 side to the power-receiving connector 101 side, when the lever 6 is moved due to an operation error and the connector main body 5 of the power-feed connector 1 is positioned in the rear position, the arc discharge is prevented from being generated between the power-line terminals 4a, 104a of the power-feed connector 1 and the power-receiving connector 101. Therefore, the power-feed connector 1 and the power-receiving connector 101 are prevented from being damaged.

Further, according to the connector fitting structure 10 of the present invention, while both cases 2, 102 of both connectors 1, 101 are locked with each other and the connector main body 5 of the power-feed connector 1 is positioned in the rear position, the signal-line terminal 4b of the power-feed connector 1 is in non-contact with the signal-line terminal 104b of the power-receiving connector 101. Therefore, while the electric power is supplied from the power-feed connector 1 side to the power-receiving connector 101 side, when the lever 6 is moved due to an operation error and the connector main body 5 of the power-feed connector 1 is positioned in the rear position, the power distribution between the power-line terminals 4a, 104a can be stopped (namely, by separating the signal-line terminals 4b, 104b from each other, the system of the power-feed device becomes down). Further, when the power-line terminals 4a, 104a are separated from each other after the power distribution between the power-line terminals 4a, 104a is stopped, the arc discharge is surely prevented from being generated.

Incidentally, the above embodiment only shows a representative example of the present invention. The present invention is not limited to the embodiment. Namely, various modifications can be practiced within a scope of the present invention.

### REFERENCE SIGNS LIST

1 power-feed connector
2, 102 case
3a, 103a power line
4a, 104a power-line terminal
5, 105 connector main body
6 lever
7 lock arm (lock member)
10 connector fitting structure
101 power-receiving connector

1. A connector fitting structure comprising:
a power-feed connector; and
a power-receiving connector configured to be fitted with the power-feed connector,
said power-feed connector including:
a case;
a connector main body mounted movably forward and backward in the case and having a power-line terminal connected to a power line;
a lever for moving the connector main body forward and backward relative to the case; and
a lock member for locking both cases of both connectors with each other by engaging with a case of the power receiving connector,
wherein when the power-feed connector and the power-receiving connector are moved close to each other, the lock member locks both cases of both connectors with each other,
wherein while both cases of both connectors are locked with each other and the connector main body of the power-feed connector is positioned in a front position, the connector main body of the power-feed connector is fitted with a connector main body of the power-receiving connector, and
wherein while both cases of both connectors are locked with each other and the connector main body of the power-feed connector is positioned in a rear position, the power-line terminal of the power-feed connector is in contact with a power-line terminal of the power-receiving connector.

2. The connector fitting structure as claimed in claim 1,
wherein both main bodies of both connectors include the power-line terminals connected to the power line and signal-line terminals connected to a signal line,
wherein while both cases of both connectors are locked with each other and the connector main body of the power-feed connector is positioned in the front position, the signal-line terminal of the power-feed connector is in contact with the signal-line terminal of the power-receiving connector, and
wherein while both cases of both connectors are locked with each other and the connector main body of the power-feed connector is positioned in the rear position, the signal-line terminal of the power-feed connector is in non-contact with the signal-line terminal of the power-receiving connector.
